(19) United States
(12) Patent Application Publication
(10) Pub. No.: US 2012/0043154 A1
(43) Pub. Date: Feb. 23, 2012

(54) HYDRAULIC SYSTEM

(76) Inventors: Marcus Bitter, Mannheim (DE); Wolfgang Reck, Lambsheim (DE); Mario Seebode, Mannheim (DE); Ulrich Hoppe, Mannheim (DE); Thilo Kazimiers, Bahretal (DE); Josef Peters, Mannheim (DE)

(21) Appl. No.: 13/213,289

(22) Filed: Aug. 19, 2011

(30) Foreign Application Priority Data
Aug. 19, 2010 (DE) 10 2010 039 509.9

(51) Int. Cl. B62D 5/06

(52) U.S. Cl. 180/442

(57) ABSTRACT

A hydraulic system for a mobile working machine includes a hydraulic pump, a steering valve, a steering actuator controlled by the steering valve, a first hydraulic line which extends between the hydraulic pump and the steering valve, and a hydraulic storage unit which is connected with the first hydraulic line via a second hydraulic line). So as to optimize a pressure state for the hydraulic system, a throttle connected in parallel with a check valve is located in the second hydraulic line. The check valve permits one-way fluid flow in a direction away from the hydraulic storage unit.

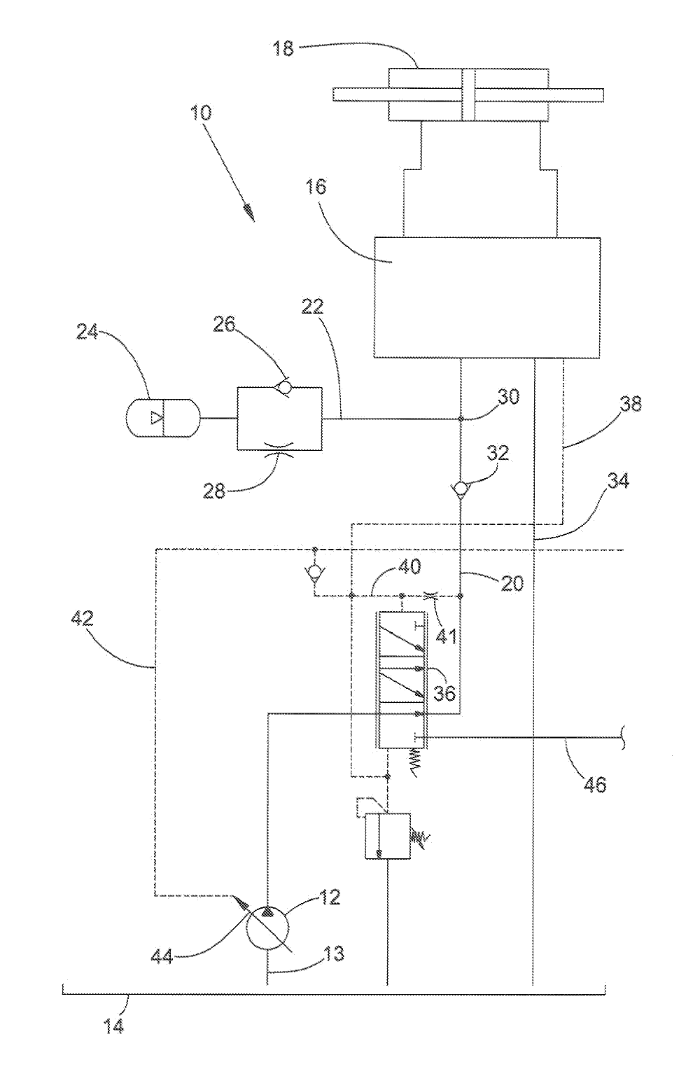

### FIELD OF THE INVENTION

The present disclosure relates to a hydraulic system for a mobile working machine.

### BACKGROUND OF THE INVENTION

Hydraulically controlled steering devices are used for mobile working machines, for example, farm tractors, harvesting machines, or construction machines. Usually, such working machines are equipped with other hydraulic devices, in addition to the hydraulic steering device, such as brake systems, suspensions, power lifts, hydraulic motors, etc., which are supplied hydraulically via a hydraulic main supply pump. The control of several hydraulic devices with only one hydraulic main supply pump takes place via so-called priority control valves, which are controlled as a function of load pressure (Load-Sensing (LS)-control) and guarantee that with high total hydraulic loads, a reduced hydraulic supply of safety-relevant devices, such as a brake system or a steering device, cannot occur. An interconnection of such priority control valves, which, as a rule, is relatively complex and comprehensive, and a necessarily large-volume design of main supply pumps can, in certain operating states, be at the expense of reaction times of the hydraulic components. Thus, large-volume hydraulic pumps require larger priority control valves, which, in turn, have slower response times. The higher the number of various hydraulic loads or devices, the more comprehensive is the priority control system or the load pressure-dependent control pressure lines. On one hand, longer control pressure lines and a higher number of these lines are connected in this way. Both have a negative effect on the response time and the reaction capacity of the entire hydraulic system. If a priority control valve and/or a pressure-producing hydraulic pump do not react fast enough, this can—with reference to a hydraulic steering device—be noticed as an interruption in the steering and perceived as disturbing by the operator of a vehicle. It is also disadvantageous that on some mobile working machines with high volume power requirements, in particular, construction machines, the pump reaction times are slowed down because of reasons of provisioning stability, which likewise can lead to a slowing down of the steering reactions, if high pressure and volume flow are quickly needed by the steering.

The response times or reaction times to the general pressure buildup of an aforementioned hydraulic system are to be seen as critical for a steering device both with systems with gear pumps (fixed displacement pumps) and also with variable displacement pumps (variable), since a hydraulic steering device will always be limited, in its reaction time, by the pressure-producing component, so that for this reason, quick reaction times are desired, which, in turn, can contribute to instabilities of the hydraulic system or the individual hydraulic devices.

Manufacturers of priority control valves make an effort to optimize the reaction times with the aid of optimized control edges and the use of hydraulic apertures on their valves. Other solutions provide for the use of a second or several supply pumps, .wherein a separate supply pump is proposed for the exclusive supply or also for the additional supply for a steering device with reduced hydraulic service, which, however, is connected with additional costs, or parts and construction expense.

Furthermore, a way is known for counteracting a reduced hydraulic supply of the steering device in that a pre-filled hydraulic storage unit is provided, which, in case of need, is correspondingly discharged and cancels a reduced hydraulic supply. Thus, EP 1293669 A2 discloses a hydraulic system for a steering device with a hydraulic storage unit, which is connected to a steering pump and to a steering actuator, wherein the specific conveying volume of the steering pump is dimensioned in such a way that with low operating speeds of the combustion engine, the operation of the steering actuator requires the supply of pressure from the steering pump and the hydraulic storage unit. Only upon exceeding a certain operating speed can the hydraulic need of the steering device be covered from only the steering pump.

Such an arrangement of the hydraulic storage unit counteracts a reduced hydraulic supply, but is disadvantageously connected with a delay in the total pressure buildup and, on the other hand, in that, as a whole, an “imprecise,” fluctuating or elastic pressure state is established for the entire steering device.

### SUMMARY

According to an aspect of the present disclosure, a hydraulic system for a mobile working machine includes a hydraulic pump, a steering valve, a steering actuator controlled by the steering valve, a first hydraulic line communicating the hydraulic pump to the steering valve, and a hydraulic storage unit connected to the first hydraulic line by a second hydraulic line. A throttle is connected in parallel with a check valve in the second hydraulic line. The check valve permits one-way fluid flow in a direction away from the hydraulic storage unit. On one hand, such an arrangement makes it possible to have a quick discharge of the hydraulic storage unit when a reduced hydraulic supply of the steering device occurs and thus the reaction capacity of the hydraulic steering device is improved and, on the other hand, this guarantees that the hydraulic storage unit loads up only slowly during a steering movement, so that there is no substantial delay of the pressure buildup and, as a whole, the stability of the pressure state is improved and, all total, a relatively stable and relatively uniform pressure state is established. In particular, this prevents the hydraulic storage unit from being able to load up too rapidly and thus from generating a pressure decline. The aperture or throttle provides for a slow loading of the hydraulic storage unit, could also be replaced thereby by another similar volume flow-reducing means. The check valve makes possible a quick discharging of the hydraulic storage unit, in the direction of the steering device, in case of a reduced hydraulic supply, wherein, the other way around, for the loading of the hydraulic storage unit, the volume flow is exclusively conducted through the aperture or the throttle. Here too, other similar hydraulic means could perhaps be used.

A further check valve is located between the hydraulic pump and the second hydraulic line in the first hydraulic line. The further check valve permits one-way fluid flow away from the pump. The further check valve ensures that a discharge of the hydraulic storage unit results in a hydraulic supply taking place only in the direction of the steering device, so that the effect attainable by a discharge of the hydraulic storage unit is not reduced by a pressure relief in the direction of other components of the hydraulic system. Here too, other similar hydraulic means could perhaps be used.

A control valve is placed between the hydraulic pump and the second hydraulic line in the first hydraulic line, and provides a separate control of the steering device—that is, a hydraulic supply control, separate from other hydraulic devices or components.

The control valve could also be designed thereby as a priority control valve, by means of which the first hydraulic line could be connected with other hydraulic devices, in addition to the steering valve. Thus, the priority control valve could be a hydraulic priority control system, wherein another or several other priority control valves or other hydraulic devices or loads could follow the priority control valve. For example, a hydraulic brake system with a higher priority than the steering device or other devices, such as a hydraulic suspension or power lift with a lower priority, could be correlated with a priority valve.

The hydraulic pump could be designed as a variable displacement pump. Alternatively, a fixed displacement pump, for example, a gear pump could also be provided, which is placed in connection with additional volume flow-changing adjusting means.

In addition, load pressure-dependent control pressure lines could be provided, by means of which the hydraulic pump could be controlled as a function of the load pressure. Thus, with alternating load pressures or a changing supply need for hydraulic fluid, the hydraulic pump could be correspondingly controlled and, as a whole, the volume flow for the entire hydraulic system, in a load pressure-optimized manner.

Furthermore, load pressure-dependent control pressure lines could also be provided, by means of which the at least one control valve could be controlled. In this regard, it is also possible to connect correspondingly arranged priority valves of a priority control system with corresponding load pressure-dependent control pressure lines, so that the volume flow could be controlled for the entire hydraulic system in a load pressure-optimized manner.

### BRIEF DESCRIPTION OF THE DRAWING

The sole FIGURE is a schematic circuit diagram of a hydraulic system, according to the invention.

### DETAILED DESCRIPTION OF THE DRAWINGS

The hydraulic system 10 can be used for mobile working machines, such as, for example, farm vehicles, such as tractors, harvesting machines, self-propelled spraying machines, loading machines, in particular, telescopic loaders, but also construction machines, such as wheel loaders or excavators, etc., and forestry machines. In particular, such machines have several hydraulic devices or loads, which are supplied via only one hydraulic supply pump.

The hydraulic system 10 includes a hydraulic pump 12 (preferably a variable displacement pump), which supplies hydraulic fluid from a hydraulic tank 14, via a supply line 13, and a steering valve 16, for the control of a steering actuator 18. The steering valve 16 is connected with the hydraulic pump 12 via a first hydraulic line 20. A second hydraulic line 22 connects the first hydraulic line 20 with a hydraulic storage unit 24. A check valve 26 and a throttle or aperture 28 are connected in parallel in the second hydraulic line 22. The check valve 26 permits one-way fluid flow in a direction away from the hydraulic storage unit 24.

A second check valve 32 is placed between a connecting site 30, on which the second hydraulic line 22 is connected with the first hydraulic line 20. The check valve 32 permits one-way fluid flow in a direction away from the pump 12. Another hydraulic line 34 connects the steering valve with the hydraulic tank 14. Furthermore, a control valve 36, preferably a priority control valve, is provided between the other check valve 32 and the hydraulic pump 12 in the first hydraulic line 20. Valve 36 is controlled, in a known manner, via the load pressure control lines 38, 40, connected with the steering valve 16 and the first hydraulic line 20. Another load pressure control line 42 branches off from the aforementioned load pressure control lines 38, 40, and leads to a corresponding adjusting device 44 for the load pressure-dependent adjustment of a volume flow, delivered by the hydraulic pump 12. Another hydraulic line 46 connects the priority control valve 36 in the usual known manner with other hydraulic device or components (not shown), such as a hydraulic brake system, a hydraulic suspension, a hydraulic power lift system, or another hydraulic device of the working machine.

Accordingly, the hydraulic system conveys hydraulic fluid from the tank 14, via the hydraulic pump 12 and via the priority control valve 36, to the hydraulic steering device 16. At the same time, hydraulic fluid is conducted into the hydraulic storage unit 24 via the second hydraulic line 22, equipped with the throttle or aperture 28 so that the storage unit is slowly loaded with hydraulic fluid parallel to the supply of the hydraulic steering device 16. The steering actuator 18 can be controlled by actuation of the hydraulic steering device 16. The steering actuator 18 is coupled to a corresponding steering rod (not shown). Depending on the load of the hydraulic system 10, a corresponding volume flow is established via the load pressure lines 38, 40, 42. If as a result of operating state changes, there should be a reduced supply of the hydraulic system to such an extent that the volume flow or the hydraulic pressure declines, then the hydraulic pressure decline or the reduced hydraulic supply is automatically caught in that the hydraulic storage unit 24 discharges in the direction of the hydraulic steering device 16 via the check valve 26. At the same time, the second check valve 32 prevents the hydraulic fluid stored in the hydraulic storage unit 24 from flowing off also only in the direction of the hydraulic steering device 16.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

We claim:

1. A hydraulic system for a mobile working machine, the system having a hydraulic pump, a steering valve, a steering actuator which is controlled by the steering valve, a first hydraulic line communicating the hydraulic pump to the steering valve, and a hydraulic storage unit, connected to the first hydraulic line by a second hydraulic line, characterized by:
a throttle connected in parallel with a check valve in the second hydraulic line, the check valve permitting one-way fluid flow in a direction away from the hydraulic storage unit.

2. The hydraulic system of claim 1, wherein:
a further check valve in the first hydraulic line between the hydraulic pump and the second hydraulic line, the further check valve permitting one-way fluid flow in a direction away from the hydraulic pump.

3. The hydraulic system of claim 1, wherein:
a control valve is located in the first hydraulic line between the hydraulic pump and the second hydraulic line.

4. The hydraulic system of claim 3, wherein:
the control valve is a priority control valve for controlling a connection between the first hydraulic line and the steering valve and with other hydraulic devices.

5. The hydraulic system of claim 1, wherein:
the hydraulic pump is a variable displacement pump.

6. The hydraulic system of claim 1, further comprising:
load pressure-dependent control pressure lines for controlling the hydraulic pump as a function of a load pressure.

7. The hydraulic system of claim 3, further comprising:
load pressure-dependent control pressure lines for controlling the control valve.
